(19) United States
(12) Patent Application Publication
(10) Pub. No.: US 2016/0158926 A1
(43) Pub. Date: Jun. 9, 2016

(54) INNER POLYGONAL WRENCH STRUCTURE

(71) Applicant: YEO MING WANG, TAIPEI CITY (TW)

(72) Inventor: YEO MING WANG, TAIPEI CITY (TW)

(21) Appl. No.: 14/562,161

(22) Filed: Dec. 5, 2014

(51) Int. Cl. B25B 27/18; B25B 15/00

(52) U.S. Cl. CPC B25B 27/18; B25B 15/008

(57) ABSTRACT

An inner polygonal wrench structure comprises: a wrench handle; and an operating portion, which is connected with an end of the wrench handle and has an operating bottom surface, a plurality of wrench lateral surfaces and a tilt hole, the every two adjacent wrench lateral surfaces is a wrench end angle, the tilt hole is inclined and has a first open and a second open that are corresponding to each other at two ends thereof, wherein the first open and the second open are at different levels, the first open is higher and the second open is lower.

### BACKGROUND OF THE INVENTION

1. Field of the Invention

The present invention generally relates to a wrench tool structure, more particularly to an inner polygonal wrench structure that is able to drive/twist a worn, damaged or enlarged inner polygonal bolt.

2. Description of the Prior Art

General inner polygonal bolts or other rotary workpieces are always driven by a wrench. The shape of a wrench must be fit with the contour of the driven hole of an inner polygonal bolt, and the inner polygonal bolt is then driven by the wrench. In case of a worn, enlarged or damaged driven hole, such inner polygonal bolt may not be easily turned/driven. To solve the problem, an issued patent, numbered M384739, of Republic of China has taught related skills. Please refer to FIG. 1 and FIG. 1a, which illustrate a schematic structural view of a prior wrench tool and a cross-sectional view of the prior wrench tool. As shown in the figures, a hexagonal wrench is shaped as L-type and has a working end 91. The working end 91 is shaped as rod-type and is inserted into an accommodation hole 81 of an inner hexagonal bolt 80. The working end 91 has a working end surface 92 and six averaged urging surfaces 93, wherein the working end surface 92 is flat. At least one of the six urging surfaces 93 is adjacent to an angle Q that has a fillister 94. The fillister 94 is shaped as rectangle-type and is elongated along a direction parallel to the axial line of the working end 91. Further, the fillister 94 goes through the working end surface 92. Due to the fillister 94 of the urging surface 93, a friction/compressing force between the inner walls of the accommodation hole 81 and the six urging surfaces 93 is highly enhanced, so as to easily drive/turn the inner hexagonal bolt 80.

Although aforesaid patent, numbered M384739, is able to solve the problem, the cost to process the working end surface 91, the six urging surfaces 93 and the six fillisters 94 is highly increased. That is, such patent may not be suitable to mass-produce.

Another patent, numbered 402141, discloses a hexagonal ball wrench. One end of the hexagonal ball wrench is a ball end. The ball end is to drive a driven member and has a virtual working portion that is connected with the driven member. The ball end further has a first arc surface having a plurality of recesses and at least one engaging portion, wherein the recesses are neighbor to the engaging portion, and the distance between two adjacent recesses is not equal to another distance between other two adjacent recesses. The engaging portion and the virtual working portion are coplanar. The recesses are comparatively concave compared to the virtual working portion. More, the engaging portion is able to increase a friction force between the ball end and the driven member.

Again, although the patent, numbered 402141, is capable of increasing the friction force between the ball end and the driven member by means of the plural recesses and the engaging portion of the ball end, the cost to process the recesses may be tremendously high, so that it is not an ideal design.

Accordingly, the inventor has studied related technologies in order to develop an inner polygonal wrench structure. Hopefully, the inner polygonal wrench structure will be more controllable, convenient and economical.

### SUMMARY OF THE INVENTION

The main objective of the present invention is to provide an inner polygonal wrench structure, which is operable through the cooperation of a tilt hole of an operation portion of a wrench tool, so as to easily turn/move a worn, damaged or enlarged driven hole of a hexagonal bolt. So that, the present invention is controllable, convenient and economical.

To approach above objectives, the inner polygonal wrench structure comprises: a wrench handle; and an operating portion, which is connected with an end of the wrench handle and has an operating bottom surface, a plurality of wrench lateral surfaces and a tilt hole, the every two adjacent wrench lateral surfaces is a wrench end angle, the tilt hole is inclined and has a first open and a second open that are corresponding to each other at two ends thereof, wherein the first open and the second open are at different levels, the first open is higher and the second open is lower.

Accordingly, the first open of the tilt hole is at the wrench end angle.

Accordingly, the first open of the tilt hole is at the wrench lateral surface.

Accordingly, the second open is at the operating bottom surface.

Accordingly, the tilt hole is cooperated with an urging object.

Accordingly, the urging object is an urging rod that has a first urging end and a second urging end, the first urging end is stuck out from the first open, the second urging end is corresponding to the second open.

Accordingly, the urging object is selected from the group consisting of: flexible rope and flexible steel line.

Accordingly, the urging rod is longer than the tilt hole.

Accordingly, the first urging end of the urging rod is stuck out from the first open in order to form an urging rod handle that goes from the first urging end to the first open.

### BRIEF DESCRIPTION OF THE DRAWINGS

The objectives, spirits, and advantages of the preferred embodiments of the present invention will be readily understood by the accompanying drawings and detailed descriptions, wherein:

FIG. 1 illustrates a schematic structural view of a prior wrench tool;

FIG. 1a illustrates a cross-sectional view of the prior wrench tool;

FIG. 2 illustrates a schematic perspective view of a first preferred embodiment of the inner polygonal wrench structure of the present invention;

FIG. 3 illustrates a schematic operation view of the first preferred embodiment of the inner polygonal wrench structure of the present invention;

FIG. 4 illustrates a schematic structural view of the first preferred embodiment with an urging rod of the present invention;

FIG. 5 illustrates a first schematic operation view of the first preferred embodiment with the urging rod of the present invention;

FIG. 6 illustrates a second schematic operation view of the first preferred embodiment with the urging rod of the present invention;

FIG. 7 illustrates a third schematic operation view of the first preferred embodiment with the urging rod of the present invention;

FIG. 8 illustrates a schematic operation view of the first preferred embodiment with a rope of the present invention;

FIG. 9 illustrates a schematic structural view of a second preferred embodiment of the inner polygonal wrench structure of the present invention;

FIG. 10 illustrates a schematic operation view of the second preferred embodiment of the inner polygonal wrench structure of the present invention;

FIG. 11 illustrates a schematic structural view of a third preferred embodiment of the present invention; and

FIG. 12 illustrates another schematic structural view of the preferred embodiment of the present invention.

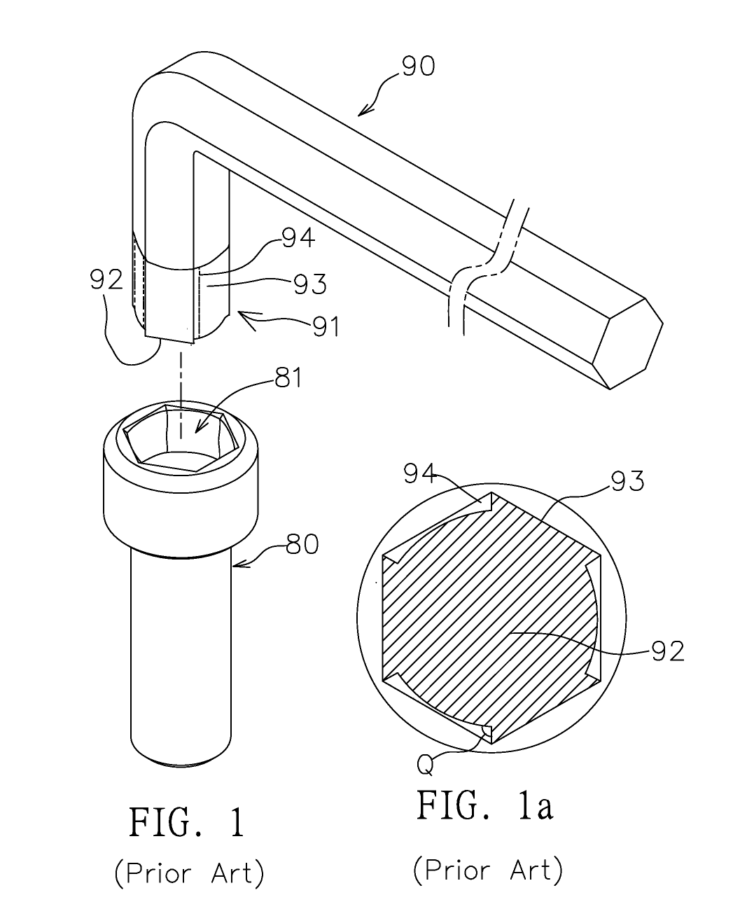

### DETAILED DESCRIPTION OF THE INVENTION

Following preferred embodiments and figures will be described in detail so as to achieve aforesaid objectives.

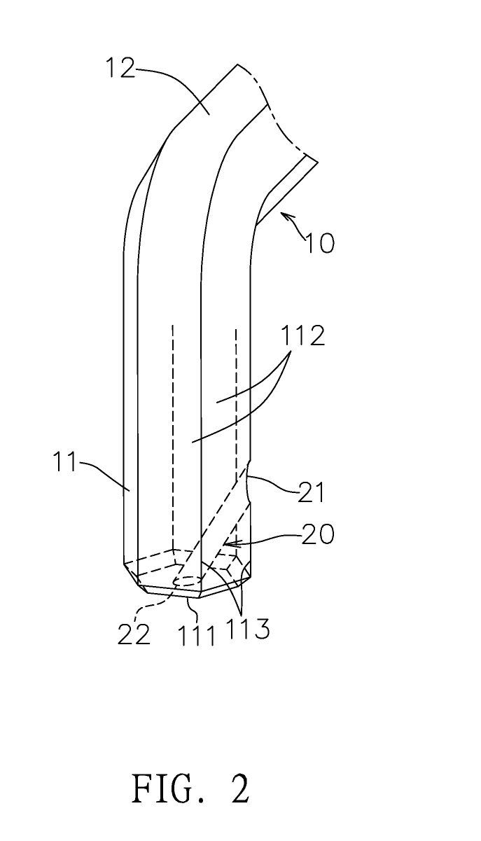

Please refer to FIG. 2, which illustrates a schematic perspective view of a first preferred embodiment of the inner polygonal wrench structure of the present invention. The inner polygonal wrench structure is a wrench tool 10, and the wrench tool 10 includes an operating portion 11 and a curved wrench handle 12 that are connected to each other. The operation portion 11 is disposed at the end of the wrench handle 12 and has an operating bottom surface 111 and a plurality of wrench lateral surfaces 112. Every two adjacent wrench lateral surfaces 112 is a wrench end angle 113, such as hexagonal wrench, which has six wrench lateral surfaces 112 and six wrench end angles 113. The operating portion 11 has a tilt hole 20 with a first open 21 and a second open 22 that are corresponding to each other at two ends thereof. Since the tilt hole 20 is inclined, the first open 21 and the second open 22 may be at different levels, that is, the distance from the first open 21 to the operating bottom surface 111 is different than the distance from the second open 22 to the operating bottom surface 111. Hence, the first open 21 is at the upper wrench end angle 113, on the other hand, the second open 22 is at the lower operating bottom surface 111. Further, the tilt hole 20 is elongated from the wrench end angle 113 to the operating bottom surface 111 so as to go through the operation portion 11.

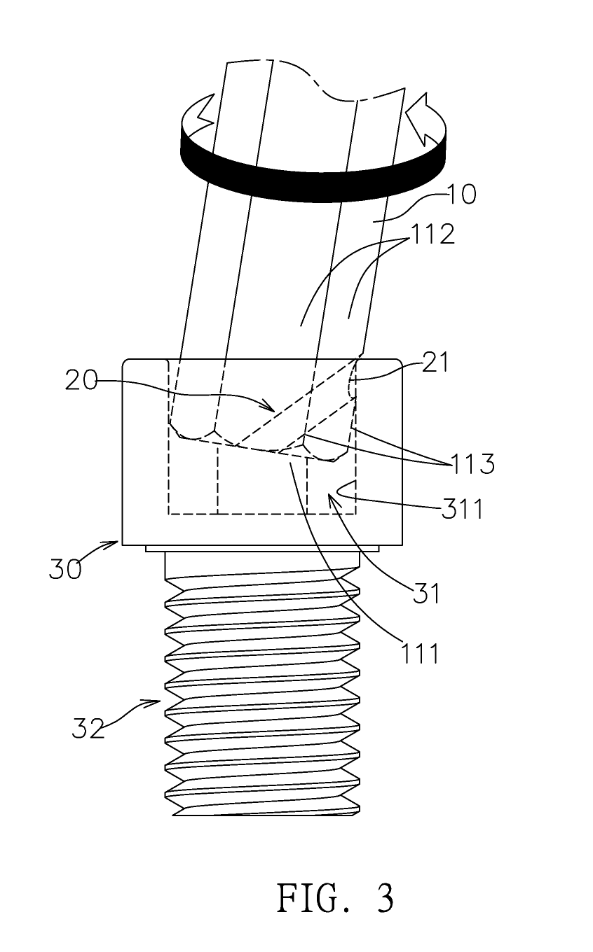

Please refer to FIG. 3, which illustrates a schematic operation view of the first preferred embodiment of the inner polygonal wrench structure of the present invention. The present invention is to drive a hexagonal bolt 30. Before a driven hole 31 of a top of a bolt rod 32 of the hexagonal bolt 30 is worn, to insert the operating portion 11 into the driven hole 31 and the operating portion 11 fitting with the driven hole 31 are then to drive the hexagonal bolt 30. On the other hand, after the hexagonal bolt 30 has been used for a period of time, the driven hole 31 is worn so as to cause the diameter thereof getting larger, and therefore the hexagonal bolt 30 cannot work properly. A solution is to obliquely plug the operating portion 11 with the tilt hole 20 into the driven hole 31, the first open 21 of the tilt hole 20 thus props against the top edge of the driven hole 31 of the hexagonal bolt 30, so as to enhance a friction force between the first open 21 and the hexagonal bolt 30. Obviously the wrench tool 10 may be easier to drive the hexagonal bolt 30.

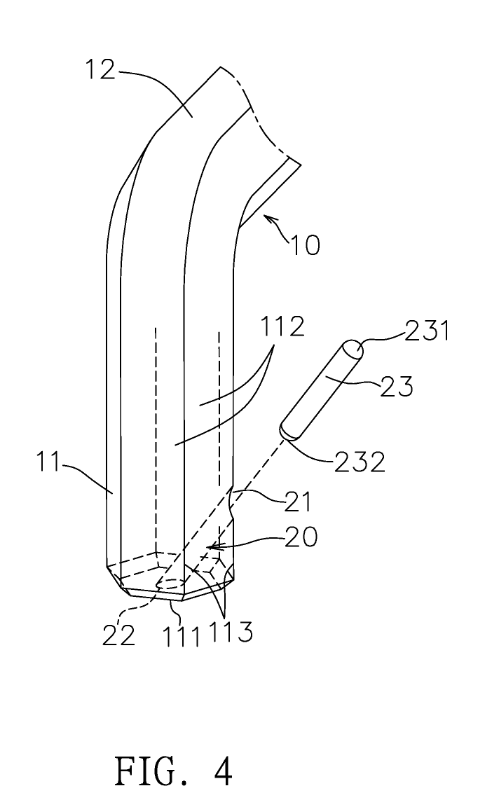

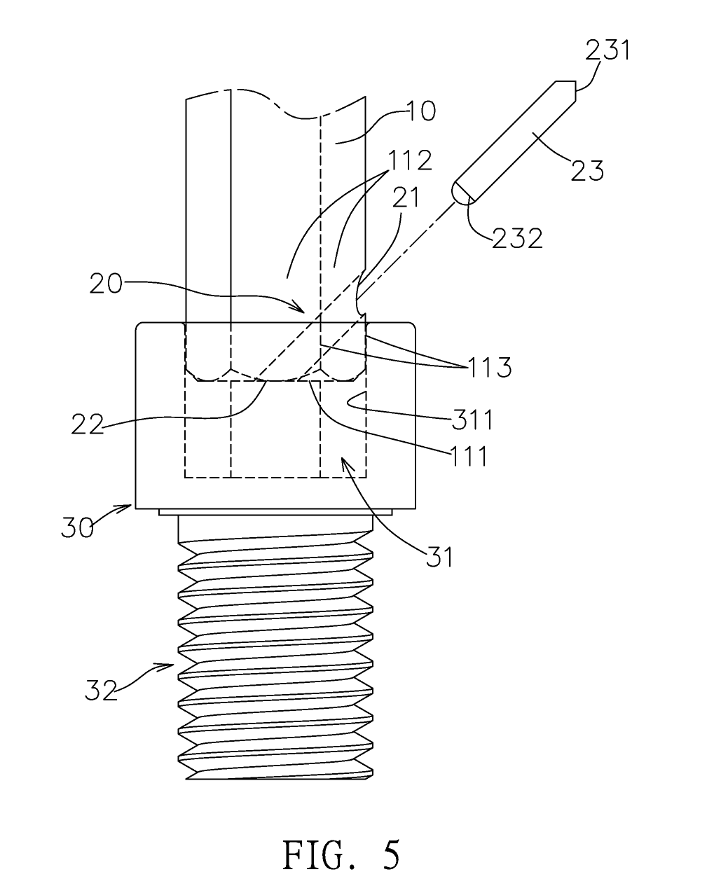

With reference to FIG. 4 and FIG. 5, which illustrate a schematic structural view of the first preferred embodiment with an urging rod of the present invention and a first schematic operation view of the first preferred embodiment with the urging rod of the present invention. The first preferred embodiment further comprises an urging rod 23, as pin. The urging rod 23 has a first urging end 231 and a second urging end 232 at two ends thereof. The first urging end 231 is corresponding to the first open 21, and the second urging end 232 is corresponding to the second open 22 as well. For the embodiment, the urging rod 23 is longer than the tilt hole 20.

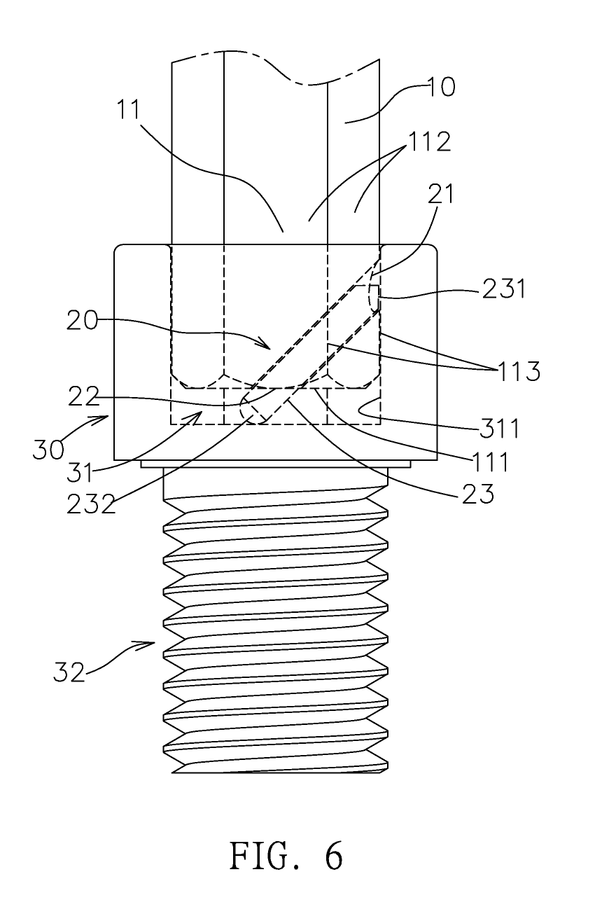

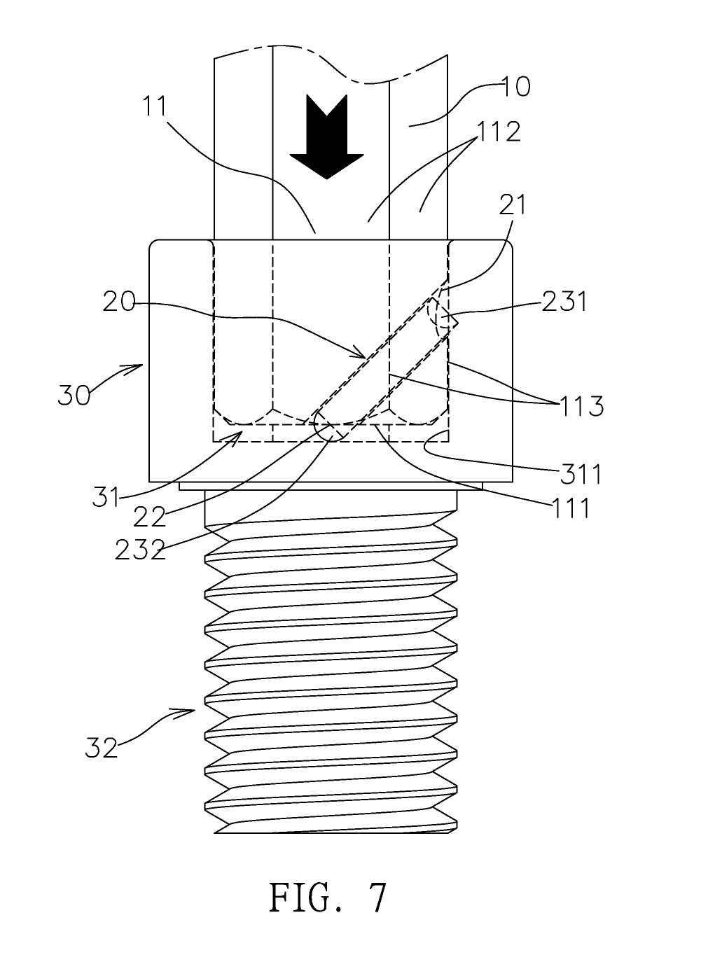

With reference to FIG. 6 and FIG. 7, which illustrate a second schematic operation view of the first preferred embodiment with the urging rod of the present invention and a third schematic operation view of the first preferred embodiment with the urging rod of the present invention. As shown in FIG. 6, the operation portion 11 of the urging rod 23 is inserted into the driven hole 31, and the second urging end 232 of the urging rod 23 may stick out from the second open 22 due to gravity. Accordingly, the second urging end 232 may be moved back into the second open 22 by the bottom surface of the driven hole 31 while the operating portion 11 moving further into the driven hole 31. According to FIG. 7, continuously the first urging end 231 of the urging rod 23 is pushed to stick out from the first open 21 of the tilt hole 20, and props against an inner wall 311 of the driven hole 31. With operation conditions or slightly inclining the operating portion 11 of the wrench tool 10, the friction force between the first urging end 231 of the first open 21 and the inner wall 311 may be enhanced, so that the operating portion 11 of the wrench tool 10 is easier to rotate the hexagonal bolt 30. As a result, the driven hole 31 of the hexagonal bolt 30 may work properly even though it is worn.

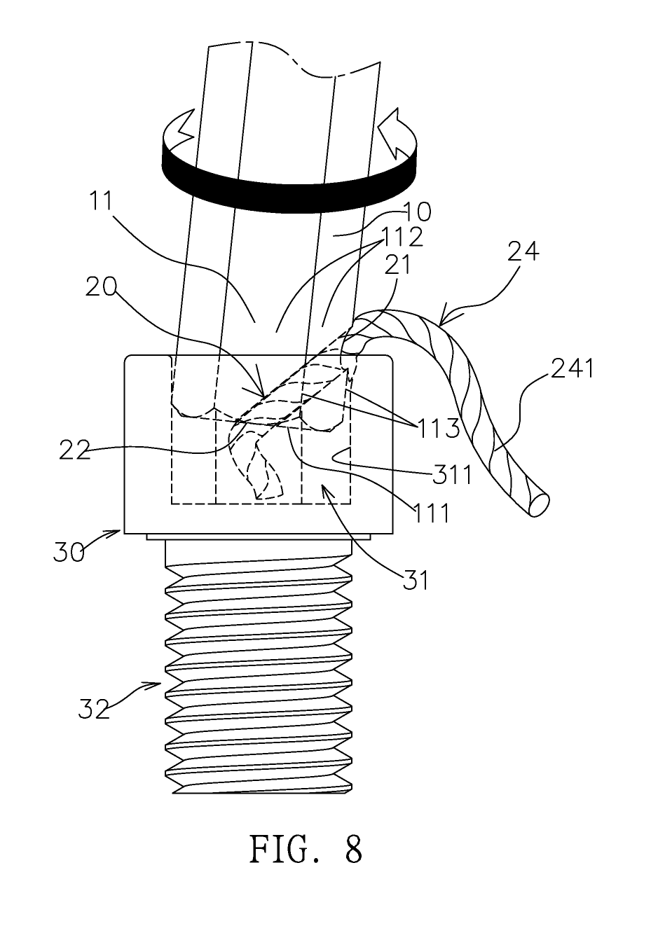

If the hexagonal bolt 30 is not cooperated with the urging rod 23, the urging rod 23 can be easily stored. The urging rod 23 is also replaced by other urging objects to cooperate with the tilt hole 20. With reference to FIG. 8, which illustrate a schematic operation view of the first preferred embodiment with a rope of the present invention. As shown in figure, the tilt hole 20 can be further equipped with a flexible rope 24, and the rope 24 has a rope end 241 that is stuck out from the first hole 21. When the operating portion 11 with the rope 24 is inserted into the driven hole 31, the rope 24 is filled out in the operating portion 11 and the driven hole 31 so as to generate an urging friction force, and the hexagonal bolt 30 is thus easily moved. As aforesaid, the urging object inserted into the tilt hole 20 is the urging rod 23, the rope 24, a steel line (not shown in figure), etc.

Using the tilt hole 20 to prop against or to cooperate with the urging rod 23 and the rope 24, the first hole 21, the first urging end 231 of the urging rod 23 and the rope end 241 of the rope 24 solves the problem of the driven hole 31 with a larger diameter due to abrasion. Also, the shortcomings in manufacturing and operation for wrench are considered.

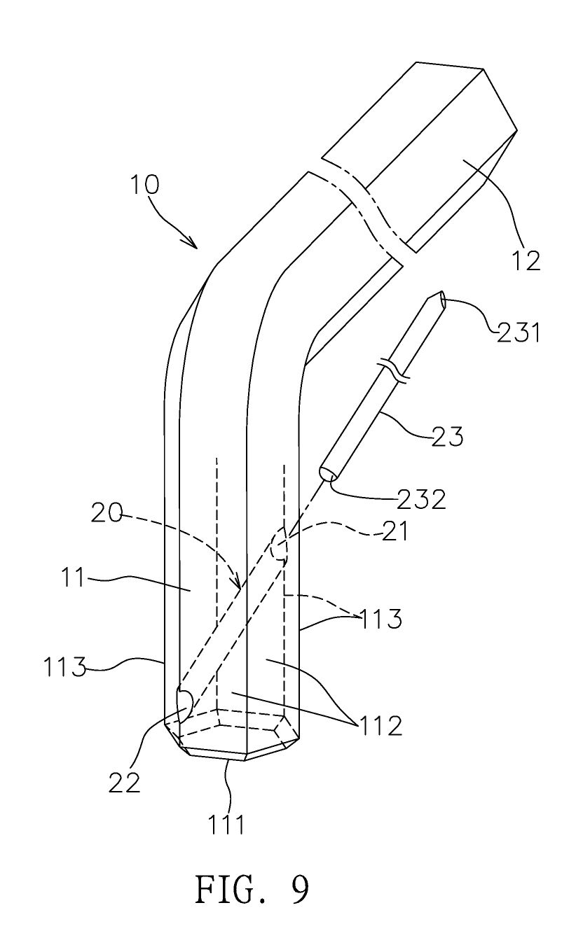

With reference to FIG. 9, which illustrates a schematic structural view of a second preferred embodiment of the inner polygonal wrench structure of the present invention. The differences between the first preferred embodiment and the second preferred embodiment are described as follows. The second hole 22 of the tilt hole 20 is at a lower wrench end angle 113, not on the operating bottom surface 111. In other words, the first hole 21 and the second hole 22 of the tilt hole 20 are disposed at different wrench end angles 113 at different levels, the first open 21 is upper and the second open 22 is lower. Therefore, the tile hole 20 is elongated from the upper first open 21 to the lower second open 22.

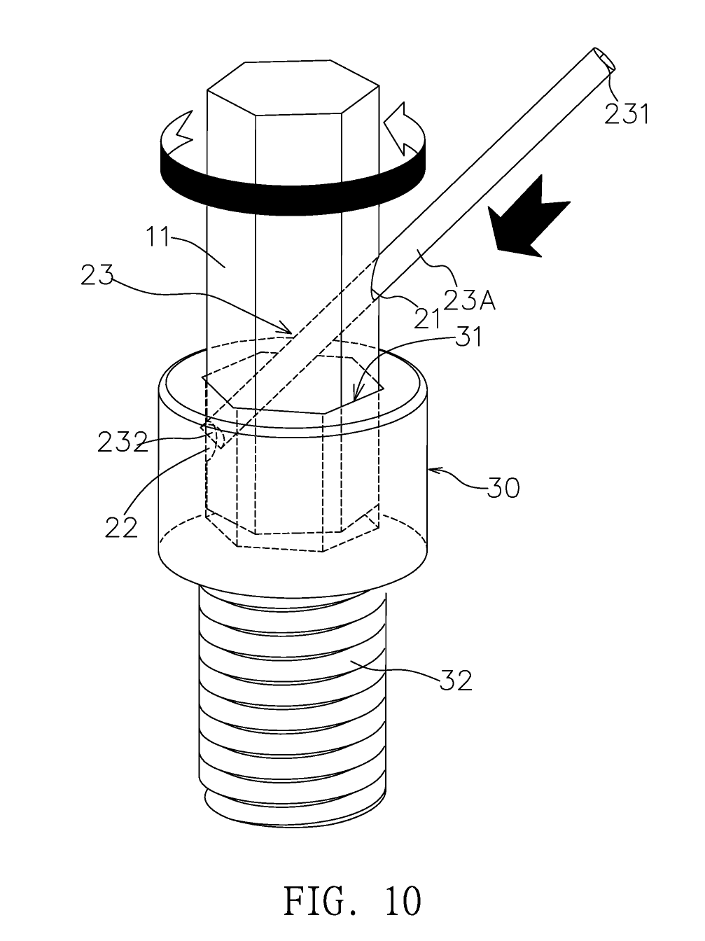

Please refer to FIG. 10, which illustrates a schematic operation view of the second preferred embodiment of the inner polygonal wrench structure of the present invention. For the second preferred embodiment, the urging rod 23 is comparatively longer. Hence, the second urging end 232 of the urging rod 23 may slightly stick out from the second open 22 and props against the inner wall 311 of the driven hole 31. The first urging end 231 of the urging rod 23 is pushed to stick out from the first open 21, and the urging rod handle 23A, with a certain length, is formed from the first urging end 231 of the urging rod 23 to the first open 21, wherein the urging rod handle 23A is for user holding to. If the hexagonal bolt 30 is worn, the user is able to use one hand to turn the wrench handle 12 of the wrench tool 10, and use another hand to press onto the urging rod handle 23A so as to let the second urging end 232 of the urging rod 23 prop against the inner wall 311 of the driven hole 31. Obviously, a friction force between the second urging end 232 of the urging rod 23 and the worn driven hole 31 is highly enhanced, so that the hexagonal bolt 30 is easily turned.

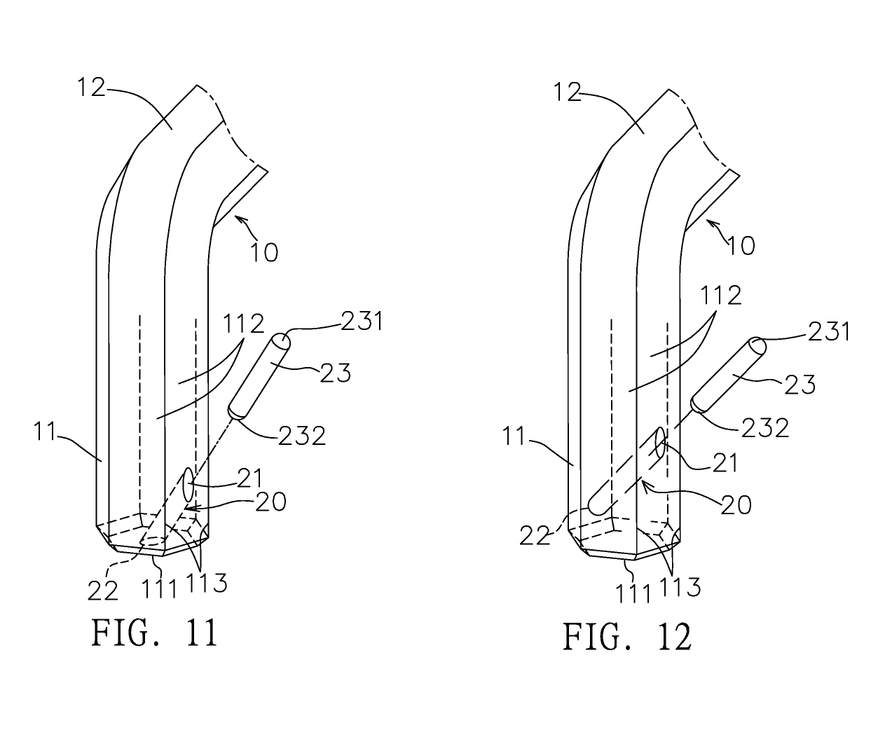

With reference to FIG. 11, which illustrates a schematic structural view of a third preferred embodiment of the present invention. The third preferred embodiment is an extendable case compared to aforesaid embodiments. The differences for the third preferred embodiment are described as follows. The first open 21 is disposed at the wrench lateral surface 112 as well. The second open 22 is at the operating bottom surface 111. Further, according to FIG. 12, which illustrates another schematic structural view of the preferred embodiment of the present invention, the second open 22 is disposed at a comparatively lower position of the wrench lateral surface 112. In other words, the first open 21 and the second open 22 are disposed at the wrench lateral surface 112 as well, but not limited thereto; or the first open 21 and the second open 22 are disposed at two positions, with different heights, of the wrench lateral surface 112 or the wrench end angle 113, etc.

The inner polygonal wrench structure of the present invention is operable through the cooperation between the operating portion 11 and the urging rod 23, so as to easily turn/move a worn, damaged or enlarged driven hole 31 of a hexagonal bolt 30. So that, the present invention is controllable, convenient and economical.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. An inner polygonal wrench structure, comprising:
a wrench handle (12); and
an operating portion (11), being connected with an end of the wrench handle (12) and having an operating bottom surface (111), a plurality of wrench lateral surfaces (112) and a tilt hole (20), the every two adjacent wrench lateral surfaces (112) being a wrench end angle (113), the tilt hole (20) being inclined and having a first open (21) and a second open (22) that are corresponding to each other, wherein the first open (21) is higher and the second open (22) is lower, the first open (21) being at the wrench end angle (113).

2. The inner polygonal wrench structure according to claim 1, wherein the tilt hole (20) is cooperated with an urging object.

3. The inner polygonal wrench structure according to claim 2, wherein the urging object is an urging rod (23) that has a first urging end (231) and a second urging end (232), the first urging end (231) being stuck out from the first open (21), the second urging end (232) being corresponding to the second open (22).

4. The inner polygonal wrench structure according to claim 2, wherein the urging object is selected from the group consisting of: flexible rope (24) and flexible steel line.

5. The inner polygonal wrench structure according to claim 1, wherein the second open (22) is at the operating bottom surface (111).

6. The inner polygonal wrench structure according to claim 1, wherein the second open (22) is at the wrench end angle (113).

7. The inner polygonal wrench structure according to claim 3, wherein the urging rod (23) is longer than the tilt hole (20), and the first urging end (231) of the urging rod (23) is stuck out from the first open (21) in order to form an urging rod handle (23A) that goes from the first urging end (231) to the first open (21).

8. An inner polygonal wrench structure, comprising:
a wrench handle (12); and
an operating portion (11), being connected with an end of the wrench handle (12) and having an operating bottom surface (111), a plurality of wrench lateral surfaces (112) and a tilt hole (20), the every two adjacent wrench lateral surfaces (112) being a wrench end angle (113), the tilt hole (20) being inclined and having a first open (21) and a second open (22) that are corresponding to each other, wherein the first open (21) being higher and the second open (22) being lower, the first open (21) being at the wrench lateral surfaces (112), the tilt hole (20) being cooperated with an urging object.

9. The inner polygonal wrench structure according to claim 8, wherein the urging object is an urging rod (23) that has a first urging end (231) and a second urging end (232), the first urging end (231) being stuck out from the first open (21), the second urging end (232) being corresponding to the second open (22).

10. The inner polygonal wrench structure according to claim 8, wherein the urging object is selected from the group consisting of: flexible rope (24) and flexible steel line.

11. The inner polygonal wrench structure according to claim 8, wherein the second open (22) is at the operating bottom surface (111).

12. The inner polygonal wrench structure according to claim 8, wherein the second open (22) is at the wrench lateral surfaces (112).

13. The inner polygonal wrench structure according to claim 9, wherein the urging rod (23) is longer than the tilt hole (20), and the first urging end (231) of the urging rod (23) is stuck out from the first open (21) in order to form an urging rod handle (23A) that goes from the first urging end (231) to the first open (21).
